(19) United States
(12) Patent Application Publication
(10) Pub. No.: US 2014/0052824 A1
(43) Pub. Date: Feb. 20, 2014

(54) CONVEYING STATE INFORMATION FOR STREAMING MEDIA

(71) Applicant: QUALCOMM INCORPORATED, San Diego, CA (US)

(72) Inventor: Kevin Roland Fall, Berkeley, CA (US)

(73) Assignee: QUALCOMM INCORPORATED, San Diego, CA (US)

(21) Appl. No.: 13/718,930

(22) Filed: Dec. 18, 2012

Related U.S. Application Data
(60) Provisional application No. 61/691,136, filed on Aug. 20, 2012.

(51) Int. Cl. H04L 29/08

(52) U.S. Cl. CPC H04L 67/104
USPC 709/219

(57) ABSTRACT

Systems, methods, and devices for transmitting a media stream are described herein. In some aspects, a device includes a state manager configured to generate state information for a portion of the media stream for a client requesting the media stream. The device further includes a transmitter configured to transmit information identifying the media stream to the client, the information identifying the media stream including the generated state information. The device also includes a receiver configured to receive the state information from the client. The device includes a content generator configured to generate an output media stream based at least in part on the received state information.

### CROSS REFERENCE TO RELATED APPLICATIONS

This application claims a priority benefit under 35 U.S.C. §119(e) from U.S. Provisional Patent Application No. 61/691,136, entitled “Conveying State Information for Streaming Media,” filed Aug. 20, 2012, which is incorporated by reference in its entirety.

### BACKGROUND

1. Field

The present invention relates to streaming media, more specifically to generating and transmitting state information for streaming media.

2. Background

Network access has been increasing in availability. Accompanying the increased availability is an expansion of the number and types of devices capable of communicating on these networks. As more devices, and thus users, gain access to the network, the content available expands as well. One content type that is gaining popularity is multimedia content such as audio and video content.

Media content may be provided as a single file including the images and audio for a media presentation. In some implementations, the media content may be streamed in smaller segments to facilitate efficient transfer of the presentation in an error tolerant, efficient (e.g., bandwidth, power, processing) manner.

An example of a streaming digital media protocol is dynamic adaptive streaming over HTTP (DASH). In some DASH implementations, a media presentation description (MPD) is provided. The MPD may include information about a media presentation such as segments (e.g., a URL) which are included in the presentation and an order for displaying the segments. This information may be used by a client to download the referenced media, such as from an HTTP server, and display the media in the proper sequence.

However, as mentioned above, the types of network and device configurations are constantly changing. If a server and client are not properly synchronized, the media presentation may be displayed out of order, missing portions, or repeated. Each of these may require additional signaling and processing to correct and/or avoid which, in some circumstances, introduces additional bandwidth, processing, and power demands on the network and devices. Accordingly, there is a need to provide systems and methods for generating and transmitting state information for streaming media.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include generating and transmitting state information for streaming media segments.

In one innovative aspect, a device for transmitting a media stream is provided. The device includes a state manager configured to generate state information for a portion of the media stream for a client requesting the media stream. The device further includes a transmitter configured to transmit information identifying the media stream to the client, the information identifying the media stream including the generated state information. The device also includes a receiver configured to receive the state information from the client. The device includes a content generator configured to generate an output media stream based at least in part on the received state information.

In another innovative aspect, a method for transmitting a media stream is provided. The method includes generating state information for a portion of the media stream for a client requesting the media stream. The method further includes transmitting information identifying the media stream to the client, the information identifying the media stream including the generated state information. The method also includes receiving the state information from the client. The method includes generating an output media stream based at least in part on the received state information and the received information identifying the portion of the media stream.

In a further innovative aspect, a device for transmitting a media stream is provided. The device includes means for generating state information for a portion of the media stream for a client requesting the media stream. The device also includes means for transmitting information identifying the media stream to the client, the information identifying the media stream including the generated state information. The device further includes means for receiving the state information from the client. The device also includes means for generating an output media stream based at least in part on the received state information.

Another device for transmitting a media stream is described in a further innovative aspect. The device includes a processor. The processor is configured to generate state information for a portion of the media stream for a client requesting the media stream. The processor is configured to transmit information identifying the media stream to the client, the information identifying the media stream including the generated state information. The processor is configured to receive the state information from the client. The processor is configured to generate an output media stream based at least in part on the received state information.

In yet another innovative aspect, a computer-readable storage medium comprising instructions executable by a processor of an apparatus is provided. The instructions cause the apparatus to generate state information for a portion of a media stream for a client requesting the media stream. The instructions also cause the apparatus to transmit information identifying the media stream to the client, the information identifying the media stream including the generated state information. The instructions further cause the apparatus to receive the state information from the client. The instructions also cause the apparatus to generate an output media stream based at least in part on the received state information.

In one or more of the above innovative aspects, the state information may indicate one or more of media streamed to the client, media to be streamed to the client, demographic information for a user of the client, technical capabilities of the client, or authorization for the client. The state information may be generated based on one or more of the portion of the media stream and the client requesting the media stream. The state information may include at least one of a pseudo-random value and a unique pseudo-random value. In some implementations, the state information may be stored, such as in a memory. The state information may be included in a query string for the portion of the media stream.

In one or more of the above innovative aspects, generating the output media stream may include obtaining the identified portion of the media stream. The generation may include identifying at least one additional content element, such as an advertisement, based at least in part on the received state information. The generation may further include identifying an insertion point of the identified portion. The generation may also include generating the output media stream including the identified additional content at the identified insertion point of the obtained portion.

In one or more of the above innovative aspects, the transmission of the information identifying the media stream may include transmission of a dynamic adaptive streaming over HTTP media presentation description file.

In one or more of the innovative aspects, the output media stream is transmitted to the client such as via a transmitter.

In one or more of the above innovative aspects, an identifier for the portion of the media stream may be transmitted to the client. The identifier may be received from the client as part of an access request. The output media stream may be generated based on the received identifier.

These and other implementations consistent with the invention are further described below with reference to the following figures.

### BRIEF DESCRIPTION OF THE DRAWINGS

FIG. 1 illustrates a functional block diagram of an exemplary video encoding and decoding system.

FIG. 2 shows a functional block diagram of an exemplary dynamic adaptive streaming over HTTP system.

FIG. 3 shows a message flow diagram for an example of state managed streaming media.

FIG. 4 shows a process flow diagram of a method for transmitting a media stream.

FIG. 5 shows a functional block diagram of a device for transmitting a media stream.

In the figures, to the extent possible, elements having the same or similar functions have the same designations.

### DETAILED DESCRIPTION

Representations of segments of portions of the media presentation may include segment identifiers such as URLs. The URL may be used to include state information regarding the client and/or the server. For example, the URL may be augmented with one or more query strings that contain the state information. By the processes described herein, servers can effectively convey state to client that may subsequently return these state indicators back to the server. The server in turn may use the state to customize the media presentation by, for example, determining an order for the segments, including content within segments (e.g., dynamic content generation), and/or inserting content between and/or within segments (e.g., advertisements). The server may use the state information to control the media presentation by, for example, providing accounting and access functions based on the state.

As the state information is included in the segment identifier, the details of maintaining state are encapsulated. Cookies, files, and other persistence mechanisms may not be needed to achieve indication of state information. This may improve processing speeds on behalf of the client and the server as well as provide a flexible way to maintain state across platforms and devices.

What will be described in further detail below are systems and methods for generating and transmitting state information in the context of a streaming media protocol. Reference will be made to DASH streaming media protocol, and, at times, referencing video as the media to be streamed. However, one of skill may recognize that one or more aspects of the described aspects may be included in other streaming media protocols such as HTTP Live Streaming and for other media types such as audio, image, and/or text-based media.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and processes may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Various aspects of embodiments within the scope of the appended claims are described below. It should be apparent that the aspects described herein may be embodied in a wide variety of forms and that any specific structure and/or function described herein is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

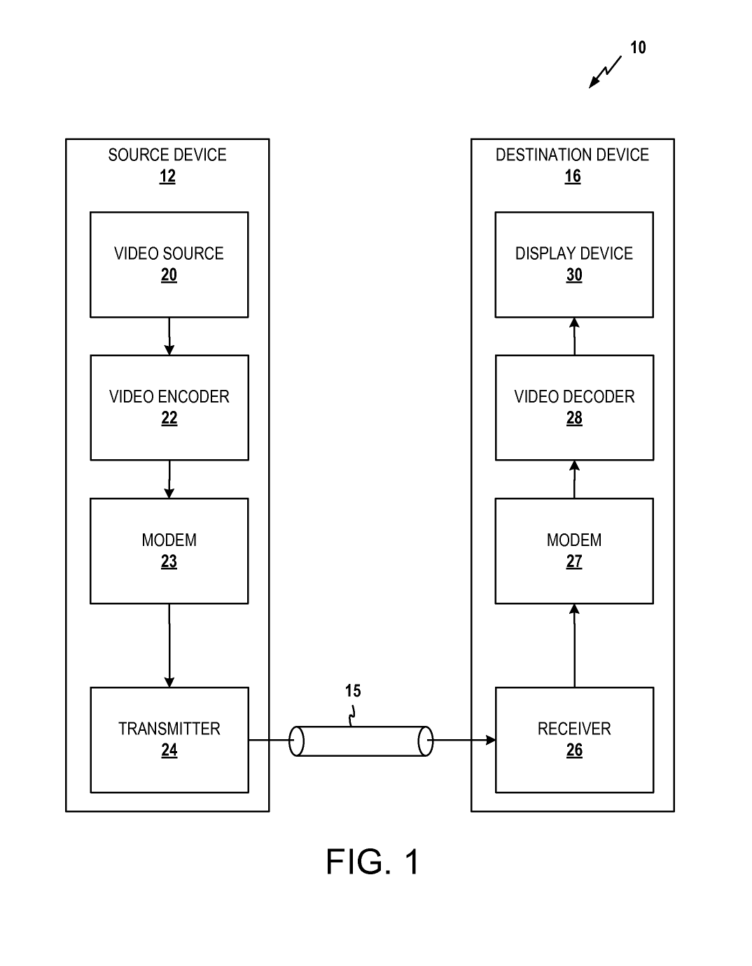

FIG. 1 illustrates a functional block diagram of an exemplary video encoding and decoding system. As shown in FIG. 1, system 10 includes a source device 12 that may be configured to transmit encoded video to a destination device 16 via a communication channel 15. Source device 12 and destination device 16 may comprise any of a wide range of devices, including mobile devices or generally fixed devices. In some cases, source device 12 and destination device 16 comprise wireless communication devices, such as wireless handsets, so-called cellular or satellite radiotelephones, personal digital assistants (PDAs), mobile media players, or any devices that can communicate video information over a communication channel 15, which may or may not be wireless. However, the techniques of this disclosure, which in one aspect concern the generation and/or transmission of state information, may be used in many different systems and settings. FIG. 1 is merely one example of such a system.

In the example of FIG. 1, source device 12 may include a video source 20, video encoder 22, a modulator/demodulator (modem) 23 and a transmitter 24. Destination device 16 may include a receiver 26, a modem 27, a video decoder 28, and a display device 30. In accordance with this disclosure, video encoder 22 of source device 12 may be configured to encode a sequence of frames of a reference image. The video encoder 22 may be configured to encode additional information associated with the images such as 3D conversion information including a set of parameters that can be applied to each of the video frames of the reference sequence to generate 3D video data. Modem 23 and transmitter 24 may modulate and transmit wireless signals to destination device 16. In this way, source device 12 communicates the encoded reference sequence along with any additional associated information to destination device 16.

Receiver 26 and modem 27 receive and demodulate wireless signals received from source device 12. Accordingly, video decoder 28 may receive the sequence of frames of the reference image. The video decoder 28 may also receive the additional information which can be used for decoding the reference sequence.

Source device 12 and destination device 16 are merely examples of such coding devices in which source device 12 generates coded video data for transmission to destination device 16. In some cases, devices 12, 16 may operate in a substantially symmetrical manner such that, each of devices 12, 16 includes video encoding and decoding components. Hence, system 10 may support one-way or two-way video transmission between video devices 12, 16, e.g., for media streaming, media playback, media broadcasting, or video telephony.

Video source 20 of source device 12 may include a video capture device, such as a video camera, a video archive containing previously captured video, or a video feed from a video content provider. As a further alternative, video source 20 may generate computer graphics-based data as the source video, or a combination of live video, archived video, and computer-generated video. In some cases, if video source 20 is a video camera, source device 12 and destination device 16 may form so-called camera phones or video phones. In each case, the captured, pre-captured or computer-generated video may be encoded by video encoder 22. As part of the encoding process, the video encoder 22 may be configured to implement one or more of the methods described herein, such as generating and/or transmitting state information. The encoded video information may then be modulated by modem 23 according to a communication standard, e.g., such as code division multiple access (CDMA) or another communication standard, and transmitted to destination device 16 via transmitter 24. Modem 23 may include various mixers, filters, amplifiers or other components designed for signal modulation. Transmitter 24 may include circuits designed for transmitting data, including amplifiers, filters, and one or more antennas.

Receiver 26 of destination device 16 may be configured to receive information over channel 15. Modem 27 may be configured to demodulate the information. Again, the video encoding process may implement one or more of the techniques described herein such as the generation and/or transmission of state information. The information communicated over channel 15 may include information defined by video encoder 22, which may be used by video decoder 28 consistent with this disclosure. Display device 30 displays the decoded video data to a user, and may comprise any of a variety of display devices such as a cathode ray tube, a liquid crystal display (LCD), a plasma display, an organic light emitting diode (OLED) display, or another type of display device.

In the example of FIG. 1, communication channel 15 may comprise any wireless or wired communication medium, such as a radio frequency (RF) spectrum or one or more physical transmission lines, or any combination of wireless and wired media. Accordingly, modem 23 and transmitter 24 may support many possible wireless protocols, wired protocols or wired and wireless protocols. Communication channel 15 may form part of a packet-based network, such as a local area network (LAN), a wide-area network (WAN), or a global network, such as the Internet, comprising an interconnection of one or more networks. Communication channel 15 generally represents any suitable communication medium, or collection of different communication media, for transmitting video data from source device 12 to destination device 16. Communication channel 15 may include routers, switches, base stations, or any other equipment that may be useful to facilitate communication from source device 12 to destination device 16. The techniques of this disclosure do not necessarily require communication of encoded data from one device to another, and may apply to encoding scenarios without the reciprocal decoding. Also, aspects of this disclosure may apply to decoding scenarios without the reciprocal encoding.

Video encoder 22 and video decoder 28 may operate consistent with a video compression standard, such as the ITU-T H.264 standard, alternatively described as MPEG-4, Part 10, and Advanced Video Coding (AVC). The techniques of this disclosure, however, are not limited to any particular coding standard or extensions thereof. Although not shown in FIG. 1, in some aspects, video encoder 22 and video decoder 28 may each be integrated with an audio encoder and decoder, and may include appropriate MUX-DEMUX units, or other hardware and software, to handle encoding of both audio and video in a common data stream or separate data streams. If applicable, MUX-DEMUX units may conform to a multiplexer protocol (e.g., ITU H.223) or other protocols such as the user datagram protocol (UDP).

Video encoder 22 and video decoder 28 each may be implemented as one or more microprocessors, digital signal processors (DSPs), application specific integrated circuits (ASICs), field programmable gate arrays (FPGAs), discrete logic circuitry, software executing on a microprocessor or other platform, hardware, firmware or any combinations thereof. Each of video encoder 22 and video decoder 28 may be included in one or more encoders or decoders, either of which may be integrated as part of a combined encoder/decoder (CODEC) in a respective mobile device, subscriber device, broadcast device, server, or the like.

While the system shown in FIG. 1 references a video system, it will be appreciated that a similar system may be configured for encoding, transmitting, and decoding other forms of media such as image data and/or audio data.

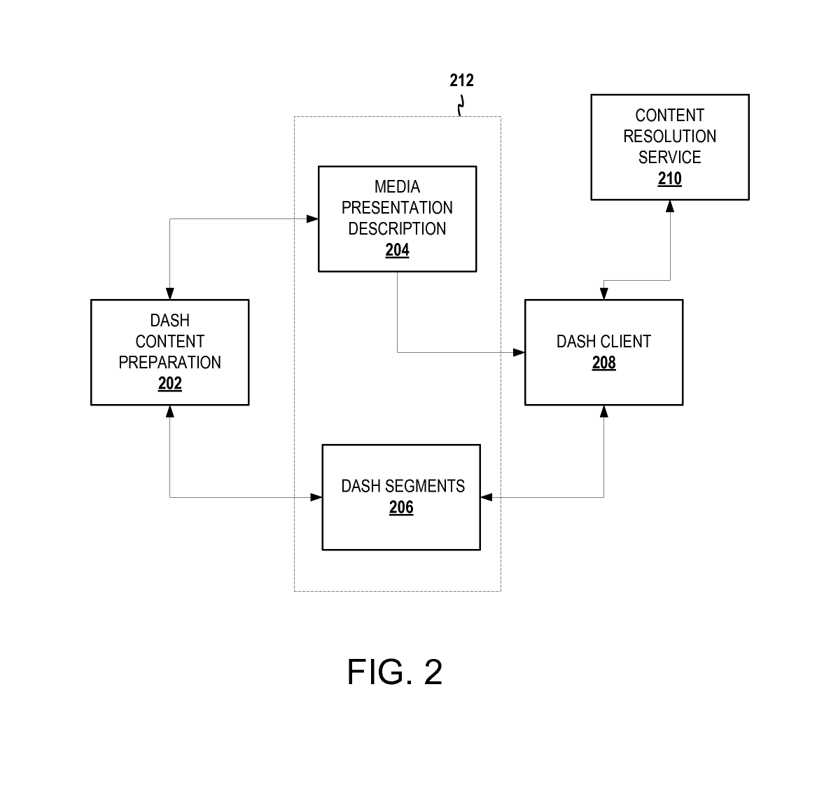

FIG. 2 shows a functional block diagram of an exemplary dynamic adaptive streaming over HTTP system. The system may incorporate one or more of the video encoding or decoding aspects described above in reference to FIG. 1. FIG. 2 shows a DASH content preparation server 202. The DASH content preparation server 202 may generate the media content. Generating the media content may include capturing the media content, identifying stored media content, segmenting the media content, or the like. Segmenting the media content may include dividing the media content into a plurality of segments. The segmentation may be based on size of the segments (e.g., memory size), duration of the segments, target client device, transmitting device, or similar factors.

A media presentation description 204 may be generated as part of content preparation. The media presentation description 204 includes information identifying all or a portion of the media content. In some implementations the media presentation description 204 is a file, such as an XML file. This file may be transmitted to a DASH client 208. The DASH client 208 may use the information included in the media presentation description 204 to obtain the media content. As shown in FIG. 2, the DASH client 208 may obtain the DASH segments 206 identified in the media presentation description 204. DASH segments are portions of the DASH content prepared by the DASH content preparation server 202.

In some implementations, the media presentation description 204 may include an explicit network address for the DASH segment. However, in some implementations, the media presentation description 204 may include generic information regarding the media stream. In such implementations, the DASH client 204 may need to obtain a network location for the media stream through communication with, for example, a content resolution service 210. The content resolution service 210 may receive a signal from the DASH client 208 including media content identifying information included in the media presentation description 204. The content resolution service 210 may be configured to transmit a response including information the DASH client may use to obtain the media content. For example, the response may include a fully qualified URL for the media content. In other implementations, the response may include multimedia broadcast multicast services information which may identify the location of the media content. Other identifiers may include a session initiation protocol identifier.

As shown in FIG. 2, the media presentation description 204 and the DASH segments are provided by a server 212. The server 212 may be an HTTP server and configured for network communication with the DASH client 208 and the DASH content preparation 202. In some implementations, the content resolution service 210 may also be hosted by the server 212.

The DASH segments 206 may be static multimedia elements such as video, image, and/or audio files. In some implementations, the DASH segments 206 may be generated dynamically. For example, if an advertising DASH segment is requested by the DASH client 208, the server 212 may generate an advertisement which includes information targeted to the requesting DASH client 208 such as including their name in a video advertisement or as part of an audio advertisement.

Similarly the media presentation description 204 may be a static file such as an XML file. In some implementations, the media presentation description 204 may be dynamically generated. For example, the server 212 may be configured to include state information in the identifiers for one or more segments included in the media presentation description 204. Accordingly, when the DASH client 208 transmits a request for a segment so identified, the server 212 may interpret the additional state information to, as discussed above, generate a dynamic DASH segment 206 for the specific DASH client 208.

In implementations where the segment identifiers are URLs, the state information may be included in the media presentation description 204 as query parameters in the URL. An example segment identifier is provided below: http://www.my-dash-server.sss/segment-service/segment-identifier?state=s29dj2va

In the example shown, the server 212 is identified by “http://www.my-dash-server.sss.” The next portion of the URL “/segment-service/segment-identifier” indicate the endpoint of the server 212 which hosts the segment. In this example, the segment-service may be the endpoint for an application which dynamically generates the segments based on the provided segment-identifier. The final portion of the URL “?state=s29dj2va” is the query string which may be used by the server 212 to identify the client requesting the segment and/or the segment. For example, when the media presentation description 204 is generated for the DASH client 208, the server 212 may store the state value for this DASH client 208. When a request for a segment including this information is received by the server 212, the server 212 may associate the request for the specific DASH client 208 and generated media presentation description 204.

In some implementations, the state information for the DASH client 208 may not be stored by the server 212. In such implementations, the state information may be used to ensure proper sequencing of segments for all DASH clients 208.

While the example above includes a single query parameter including state information, it will be appreciated that multiple parameters may be specified (e.g., “?state=s29dj2va&param1=20394”.

The state information as described may be used to identify timing information for the segments (e.g., display order, download order), identity of the DASH client 208, previous segments presented, subsequent segments to present, and the like. By including this information in the media presentation description 204, the server 212 does not necessarily need to store state information provided the server 212 includes a mechanism to decode the state parameters. Accordingly, this allows the server 212 to serve more DASH clients 208 in a more efficient manner

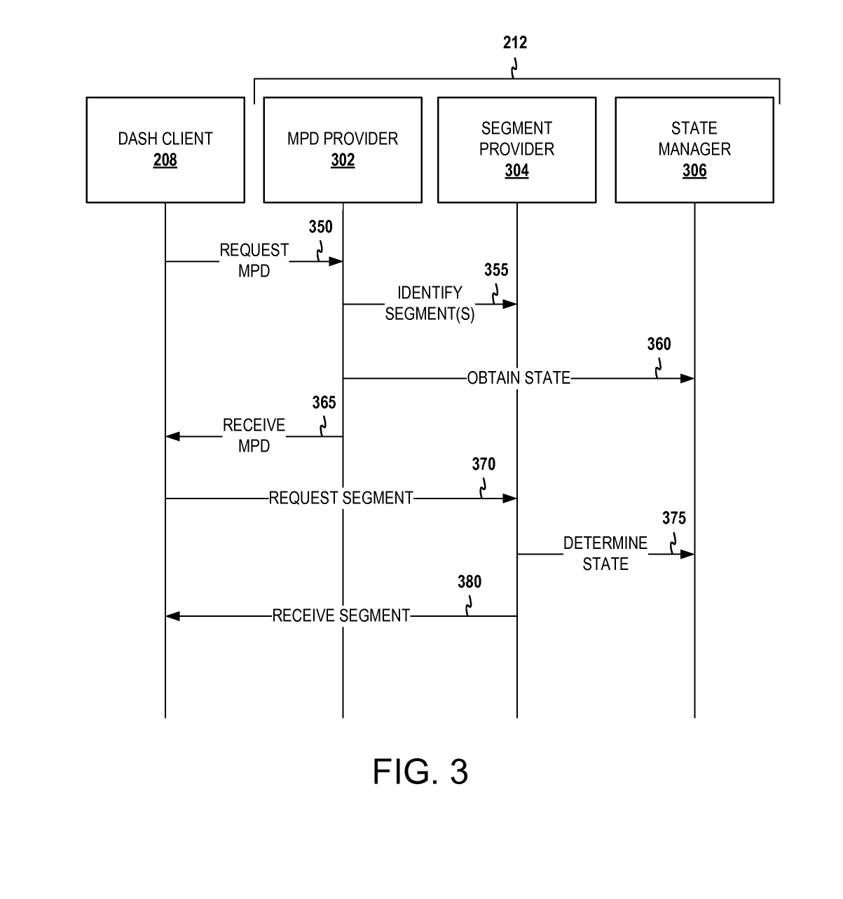

FIG. 3 shows a message flow diagram for an example of state managed streaming media. The message flow diagram includes messages exchanged between various entities of a video system. The entities shown are representative. In some implementations, one or more intermediaries may be used to provide additional functionality and/or processing such as authentication, encryption, compression, and the like. Furthermore, while several elements are shown as separate entities, one or more may be combined in a single functional unit.

As discussed above, the DASH client 208 communicates with the server 212. As shown in FIG. 3, the server 212 includes an MPD provider 302, a segment provider 304, and a state manager 306. The MPD provider 302 may be configured to provide MPDs. As discussed, these may be pre-defined files or dynamically generated upon request. Similarly, the segment provider 304 may be configured to provide media segments. These too may be pre-defined media segments or dynamically generated upon request. The state manager 306 may be configured to generate and decode state information included with segment identifiers as described herein.

The DASH client 208 may generate and transmit a request 350 for an MPD to the MPD provider 302. The MPD provider 302 may transmit one or more signals 355 to identify segments for the requested media presentation. The MPD provider 302 may also generate one or more signals 360 to the state manager 306 to identify state information for inclusion in the requested MPD. The state information may be obtained for the entire MPD and/or for each segment included in the MPD. It should also be understood that not all segments included in the MPD will include state information. In some implementations, the segment provider 304 may be configured to obtain the state information for each identified segment.

The request 350 may include information identifying the DASH client 208. For example, the request 350 may include a user identifier for the DASH client 208. Based on the information provided in the request and/or the identified segments, the state manager 306 will generate one or more state values for inclusion in the MPD. For example, if an advertising segment is identified, the state manager 306 may be configured to generate a value for inclusion in the segment for the identified user such as their name. In some implementations, the state manager 306 may generate a random or pseudo-random state identifier. The state identifier may be globally unique, unique for the client, unique for the segment, or otherwise distinguishable from other state identifiers associated with other combinations of clients and/or media presentations. In some implementations, this identifier may be stored along with other information about the requesting client for subsequent state determinations.

In some implementations, the state manager 306 may be configured to identify the segments and include this information as part of the state signal. For example, the state manager 306 may be configured to generate a state value based on the state for the client and the identified segment. The state value may be produced by, for example, a hashing function which combines the information elements into a single state identifier.

The MPD provider 302 transmits a response 365 including the MPD. The DASH client 208 may parse the MPD to identify the segments for presenting. The DASH client 208 may request 370 a segment from the segment provider 304 using the segment identifier for the segment. As discussed above, the segment identifier may include state information that may be used in generating the content of the segment. The segment provider 304 may identify state information in the request 370 such as by parsing parameters from the URL.

In implementations where the state information includes the segment identification, the request 370 may be transmitted to the state manager 306. The state manager 306 may then decode the state information to determine the state and segment values. For example, the state manager 306 may be configured to process the state information via a reverse hash function to obtain the state and segment values previously obtained (e.g., via signals 360).

As shown in FIG. 3, the segment provider 304 determines the state information by transmitting a request 375 to the state manager 306. In some implementations, the segment provider 304 may be configured to determine the state information without consulting the state manager 306. For example, if the state information includes the name of the user of the DASH client 208, this may be directly read and inserted into the requested segment.

In implementations where the state information identifies an order for display, the segment provider 304 may verify, such as via the state manager 306, that the requested segment is the next segment in the presentation. Other control aspects (e.g., content type restrictions, content quantity restrictions, content quality restrictions, bandwidth utilization, etc.) may be implemented using the state information as described herein.

The segment provider 304 then transmits a response 380 including the requested segment 380 to the DASH client 208. The DASH client 208 may then display the received segment.

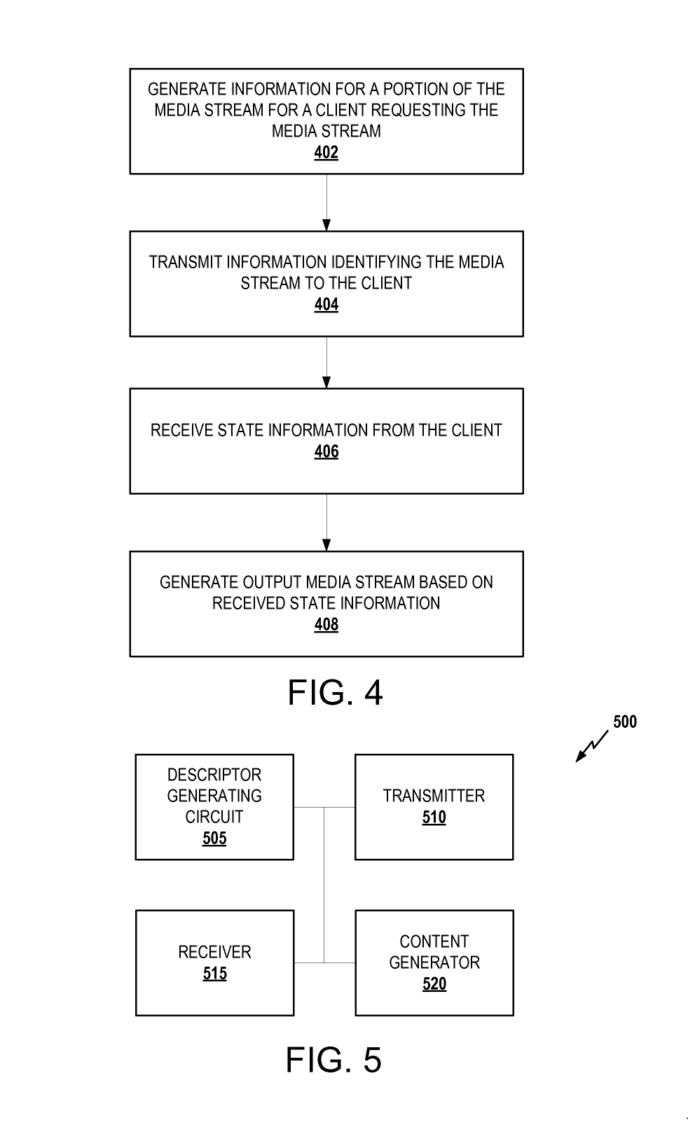

FIG. 4 shows a process flow diagram of a method for transmitting a media stream. The method may be implemented in one more of the devices described herein. At node 402, state information for a portion of the media stream is generated for a client. At node 404, the information identifying the media stream is transmitted to the client. The information identifying the media stream includes the generated state information. At node 406, state information is received from the client. At node 408, an output media stream is generated based at least in part on the received state.

As one example, the state information may indicate media streamed to the client. The state information may be transmitted as a random or pseudo-random sequence of characters. The sequence of characters may be stored in a database by the state manager. The state information may be used to lookup media previously streamed to the client associated with the state information.

In some implementations, it may be desirable to ensure the proper sequence of media segments is preserved. By comparing the previously streamed media to the identified portion of media requested by the client, the segment provided 304 can validate the identified portion in the context of the previously streamed segments. In such an implementation, the client need not maintain or transmit state information identifying which segments have been streamed. This information may be maintained by the state manager on the server side. This reduces the resources (e.g., power, bandwidth, processing time, airtime) consumed by the client to obtain a properly sequenced media presentation. This may also reduce the resources consumed by the server to provide the properly sequenced media presentation.

In some implementations, the state information may be used to generate content which is to be displayed along with the identified media stream. For example, the previously streamed content along with the requested media stream may be used to identify an advertisement to be shown before, during, after, or concurrently with the identified media stream. An insertion point for the additional content may be dynamically identified such as based on the content to be included, a characteristic of the client (e.g., technical capabilities, subscription information, etc.). The insertion point may identify a time point to include the content. The insertion point may identify a display location for the content where the content is to be displayed over the identified media stream. It may be desirable, in some implementations, to select advertisements which are related to the media streams provided to the client. Such targeting can enhance the relevance of particular messages and help reach those identified, based on previously viewed media, as having particular interests. For instance, if a client has streamed professional football content, related football content or advertising may be provided.

As another example, the state information may indicate media to be streamed to the client. The state information may be used to lookup media to be streamed to the client associated with the state information. In some implementations, it may be desirable to ensure the proper sequence of media segments is preserved. By comparing the media to be streamed with the identified portion of media requested by the client, the segment provided 304 can validate the identified portion in the context of the previously identified segments to be streamed. In such an implementation, the client need not maintain or transmit state information identifying which segments have been streamed. This information may be maintained by the state manager on the server side. This reduces the resources (e.g., power, bandwidth, processing time, airtime) consumed by the client to obtain a properly sequenced media presentation. This may also reduce the resources consumed by the server to provide the properly sequenced media presentation.

In some implementations, the state information may be used to generate content which is to be displayed along with the identified media stream. For example, the to-be streamed content along with the requested media stream may be used to identify an advertisement to be shown before, during, after, or concurrently with the identified media stream. It may be desirable, in some implementations, to select advertisements which are related to the media streams provided to the client. Such targeting can enhance the relevance of particular messages and help reach those identified, based on previously viewed media, as having particular interests. For instance, if a client has streamed professional football content, related football content or advertising may be provided. Identifying to-be streamed content may also be used to generate “teasers” which indicate a particular segment which is to be viewed in the future. Such teasers engage viewers and help increase the amount of viewing time.

As a further example, the state information may identify demographic information for a user of the client. In one implementation, the client may be configured to login to the system. A logged in user generally provides information about themselves such as age, race, gender, location, income, occupation, and the like. Once logged in, the state information may convey one or more of the demographic attributes directly or through a look up of demographic information related to the user of the logged in client. The demographic information may be used to target content as described above. The demographic information may be used to suggest content.

As yet another example, the state information may identify technical capabilities of the client. The client may be configured to display video at a certain rate, via a certain network path, using a certain bandwidth, with a certain display size. The client may have a specific hardware configuration such as processor speed or memory. Each of these factors may be used to determine how to stream media to the client. For example, if the client has a limited bandwidth and display size, a lower quality media stream of a smaller size may be transmitted to the client. The technical capabilities may also be used to target content provided to the client as described above.

As a further example, the state information may identify authorization for the client. The authorization may indicate that the client device is authorized to access the system and/or content provided thereby. The authorization may indicate content the client device is authorized to access. For example, the authorization may indicate types of content according to an MPAA rating such as G, PG, PG-13, R, etc. to a TV Parental Guidelines rating such as TV-Y, TV-G, TV-Y7, TV-14, TV-MA, etc. or other content rating system. The authorization may indicate an amount of content the client device is authorized to access (e.g., bandwidth, time, number of segments, etc.). The authorization state information may be assigned to the client by the system upon the first access. For example, the client may connect to the system anonymously. As an anonymous user, the client may be authorized to receive a limited amount of content. If the client is logged into the system, the client may be authorized for different levels of service based on, for example, a subscription. The authorization state information may be represented as an authorization token included in the state information.

FIG. 5 shows a functional block diagram of a device for transmitting a media stream. The device 500 shows only some of the features that may be included in a device for transmitting media streams. The device 500 includes a descriptor generating circuit 505, a transmitter 510, a receiver 515, and a content generator 520.

The descriptor generating circuit 505 is configured to generate state information for a portion of the media stream for a client requesting the media stream. In some implementations, the descriptor generating circuit 505 includes one or more of a processor, a memory, a pseudo-random number generator, a state manager, and a media presentation description provider. In some implementations, means for generating state information the descriptor generating circuit 505.

The transmitter 510 is configured to transmit information identifying the media stream to the client, the information identifying the media stream including the generated state information. The transmitter 510 may include one or more of an antenna, a processor, a signal generator, a network interface, an amplifier, and a memory. In some implementations, means for transmitting information identifying the media stream includes the transmitter 510.

The receiver 515 is configured to receive the state information from the client. The receive 515 may include one or more of an antenna, a processor, a signal processor, a network interface, and a memory. In some implementations, means for receiving state information includes the receiver 515.

The content generator 520 is configured to generate an output media stream based at least in part on the received state information. The content generator 520 may include one or more of a processor, an encoder, a sensor (e.g., camera), and a segment provider. In some implementations, means for generating an output media stream includes the content generator 520.

As used herein, the terms “determine” or “determining” encompass a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, a phrase referring to “at least one of a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by an encoding device and/or decoding device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a video processing device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A device for transmitting a media stream, the device comprising:
a state manager configured to generate state information for a portion of the media stream for a client requesting the media stream;
a transmitter configured to transmit information identifying the media stream to the client, the information identifying the media stream including the generated state information;
a receiver configured to receive the state information from the client; and
a content generator configured to generate an output media stream based at least in part on the received state information.

2. The device of claim 1, wherein the state information indicates one or more of media streamed to the client, media to be streamed to the client, demographic information for a user of the client, technical capabilities of the client, or authorization for the client.

3. The device of claim 1, wherein transmitting the information identifying the portion of the media stream comprises transmitting a dynamic adaptive streaming over HTTP media presentation description file.

4. The device of claim 1, wherein the state manager is configured to generate state information based on one or more of the portion of the media stream and the client requesting the media stream.

5. The device of claim 1, wherein generating state information includes generating at least one of a pseudo-random value and a unique pseudo-random value.

6. The device of claim 1, further comprising a memory, wherein the state manager is configured to store at least a portion of the state information in the memory.

7. The device of claim 1, wherein generating output media stream comprises:
obtaining the identified portion of the media stream;
identifying at least one additional content element based at least in part on the received state information;
identifying an insertion point of the identified portion; and
generating the output media stream including the identified additional content at the identified insertion point of the obtained portion.

8. The device of claim 7, wherein the additional content element includes an advertisement.

9. The device of claim 1, wherein transmitting the state information comprises including the state information in a query string for the portion of the media stream.

10. The device of claim 1, wherein the transmitter is further configured to transmit the generated output media stream to the client.

11. The device of claim 1, wherein the information identifying the media stream includes an identifier for the portion of the media stream, wherein the receiver is further configured to receive the identifier, and wherein the content generator is further configured to generate the output media stream based on the identifier.

12. A method for transmitting a media stream, the method comprising:
generating state information for a portion of the media stream for a client requesting the media stream;
transmitting information identifying the media stream to the client, the information identifying the media stream including the generated state information;
receiving the state information from the client; and
generating an output media stream based at least in part on the received state information and the received information identifying the portion of the media stream.

13. The method of claim 12, wherein the state information indicates one or more of media streamed to the client, media to be streamed to the client, demographic information for a user of the client, technical capabilities of the client, or authorization for the client.

14. The method of claim 12, wherein transmitting the information identifying the portion of the media stream comprises transmitting a dynamic adaptive streaming over HTTP media presentation description file.

15. The method of claim 12, wherein generating state information is based on one or more of the portion of the media stream and the client requesting the media stream.

16. The method of claim 12, wherein generating state information includes generating at least one of a pseudo-random value and a unique pseudo-random value.

17. The method of claim 12, further comprising storing at least a portion of the state information.

18. The method of claim 12, wherein generating output media stream comprises:
obtaining the identified portion of the media stream;
identifying at least one additional content element based at least in part on the received state information;
identifying an insertion point of the identified portion; and
generating the output media stream including the identified additional content at the identified insertion point of the obtained portion.

19. The method of claim 18, wherein the additional content element includes an advertisement.

20. The method of claim 12, wherein transmitting the state information comprises including the state information in a query string for the portion of the media stream.

21. The method of claim 12, further comprising transmitting the generated output media stream to the client.

22. The method of claim 12, wherein the information identifying the media stream includes an identifier for the portion of the media stream, wherein the method further comprises receiving the identifier, and wherein generating the output media stream is further based on the received information identifying the portion of the media stream.

23. A device for transmitting a media stream, the device comprising:
a processor, the processor configured to:
generate state information for a portion of the media stream for a client requesting the media stream;
transmit information identifying the media stream to the client, the information identifying the media stream including the generated state information;
receive the state information from the client; and
generate an output media stream based at least in part on the received state information.

24. A device for transmitting a media stream, the device comprising:
means for generating state information for a portion of the media stream for a client requesting the media stream;
means for transmitting information identifying the media stream to the client, the information identifying the media stream including the generated state information;
means for receiving the state information from the client; and
means for generating an output media stream based at least in part on the received state information.

25. A computer-readable storage medium comprising instructions executable by a processor of an apparatus, the instructions causing the apparatus to:
generate state information for a portion of a media stream for a client requesting the media stream;
transmit information identifying the media stream to the client, the information identifying the media stream including the generated state information;
receive the state information from the client; and
generate an output media stream based at least in part on the received state information.
